(19) United States
(12) Patent Application Publication
(10) Pub. No.: US 2025/0119757 A1
(43) Pub. Date: Apr. 10, 2025

(54) NETWORK NODE, USER EQUIPMENT, METHOD AND COMPUTER PROGRAM

(71) Applicant: Nokia Technologies Oy, Espoo (FI)

(72) Inventors: Samer BAZZI, Munich (DE); Mohammad SOLIMAN, Munich (DE); Martin KOLLÁR, Kosice (SK)

(21) Appl. No.: 18/906,474

(22) Filed: Oct. 4, 2024

(30) Foreign Application Priority Data
Oct. 6, 2023 (GB) 2315385.1

(51) Int. Cl. H04W 16/18; H04W 24/08

(52) U.S. Cl. CPC H04W 16/18; H04W 24/08

(57) ABSTRACT

A network node for supporting providing radio coverage within a plurality of cells within a radio communication network. The network node is configured to evaluate a quality of service that may be provided to a user equipment within at least one area of radio coverage provided by the network node and to generate an indication of the quality of service for transmission to another network node. The receiving network node may use the quality of service indication in a handover decision to prioritise cells providing a higher quality of service.

### TECHNOLOGICAL FIELD

Various example embodiments relate to radio communication networks and to ways of prioritising cells in handover decisions.

### BACKGROUND

As user equipment (UE) moves through a wireless communication system, it may move through cells that comprise regions of radio coverage that are supported or controlled by one or more network node. Maintaining an ability for a UE to communicate effectively with the wireless communication system as it moves through regions of radio coverage is typically referred to as mobility. When selecting a cell to handover to, the signal strength of different cells in the vicinity of the user equipment may be considered. Different user equipment may have different requirements and these requirements may also influence the suitability of a potential target cell.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the disclosure there is provided a network node for supporting providing radio coverage within a plurality of cells within a radio communication network, said network node comprising: at least one processor; and at least one memory storing instructions that when executed by the at least one processor cause the network node at least to perform: evaluating a quality of service that may be provided to a user equipment within at least one area of radio coverage provided by said network node; generating a corresponding at least one indication of said quality of service; and transmitting said at least one indication to a further network node within said radio communication network.

It was recognised that different network nodes have different capabilities and may provide different levels of quality of service QoS in different areas of their radio coverage, and that this may be a relevant factor when deciding on a suitable or preferred target for a handover to a particular user equipment. This information can only be used if it is available to the network node making the handover decision. Thus, embodiments seek to provide a mechanism that allows information regarding the QoS provided in an area of radio coverage supported or controlled by a network node to be sent to one or more further network nodes. This may allow the receiving network nodes to have visibility of relevant QoS information when selecting a target cell.

The QoS provided within an area of radio coverage may be evaluated by the node, by measuring QoS factors such as average packet delay and bit rate within one or more cells that it controls. The network node may then generate an indication of the measured or evaluated QoS for a particular area, the indication may indicate the actual evaluated QoS, or it may be a derivation of it, for example it may indicate a measured value being below or above a particular threshold value or it may indicate an average value, for a region or for several QoS parameters.

In some example embodiments, said network node is caused to perform: said evaluating, generating and transmitting during a procedure for setting up a link between said network node and said further network node.

In some example embodiments, said network node is caused to perform: said evaluating, generating and transmitting in response to a request from said further network node.

In some example embodiments, said request comprises an indication of type of quality of service data required. There may be different types of quality of service data, such as cell packet loss rate, cell bit rate or cell packet delay and the type to be sent may be indicated in the request.

In some example embodiments, said request comprises an indication of a predetermined time period after which an updated indication should be sent.

In some example embodiments, said network node is caused to perform: transmitting said at least one indication to said further network node during a procedure for setting up a link between said network node and said further network node.

In some example embodiments, said network node is further caused to perform: re-evaluating said quality of service and generating and transmitting an updated at least one indication after a predetermined time period.

In some example embodiments, said network node is further caused to perform: determining when said evaluated quality of service falls below or rises above a predetermined threshold value and in response generating and transmitting an updated at least one indication.

In some example embodiments, said network node is caused to perform said determining in response to receipt of a request from said further network node for updates to said quality of service indications.

In some example embodiments, said network node is further caused at least to perform: receiving at least one indication of a quality of service that may be provided to a user equipment within at least one area of radio coverage provided by at least one further network node; storing said at least one indication; using said stored at least one indication as a factor in selecting a target cell in a handover procedure, cells providing a higher quality of service being prioritised over cells providing a lower quality of service.

According to various, but not necessarily all, example embodiments of the disclosure there is provided a network node for supporting providing radio coverage within a plurality of cells within a radio communication network, said network node comprising: means for evaluating a quality of service that may be provided to a user equipment within at least one area of radio coverage provided by said network node; means for generating a corresponding at least one indication of said quality of service; and means for transmitting said at least one indication to a further network node within said radio communication network.

The means may perform the optional features set out in relation to the apparatus mentioned above.

According to various, but not necessarily all, example embodiments of the disclosure there is provided a network node for supporting providing radio coverage within a plurality of cells within a radio communication network, said network node comprising: circuitry configured to evaluate a quality of service that may be provided to a user equipment within at least one area of radio coverage provided by said network node; circuitry configured to generate a corresponding at least one indication of said quality of service; and circuitry configured to transmit said at least one indication to a further network node within said radio communication network.

The circuitry may be configured perform the optional features set out in relation to the apparatus mentioned above.

According to various, but not necessarily all, example embodiments of the disclosure there is provided a network node for supporting providing radio coverage within a plurality of cells within a radio communication network, said network node comprising: at least one processor; and at least one memory storing instructions that when executed by the at least one processor cause the network node at least to perform: receiving at least one indication of a quality of service that may be provided to a user equipment within at least one area of radio coverage provided by at least one further network node; storing said at least one indication; using said stored at least one indication as a factor in selecting a target cell in a handover procedure.

In some example embodiments, cells providing a higher quality of service are prioritised over cells providing a lower quality of service.

Providing a network node with information regarding the quality of service provided in one or more areas of radio coverage by another network node allows the network node to use this as a factor when selecting a target cell in a handover procedure. The QOS may be an important factor, depending on a user equipment's service requirements and thus, providing this information so that it can be considered when making a handover decision may improve the handover decision and help avoid or at least reduce handovers to cells where a quality of service required by the user equipment cannot be met or can only barely be met.

In some example embodiments, said network node is caused to perform: prior to receiving said at least one indication: generating a request for said at least one indication; and transmitting said request to said at least one further network node.

In some example embodiments said request is transmitted during a procedure for setting up a link between said network node and said at least one further network node.

In some example embodiments, said receiving said at least one indication is performed during a procedure for setting up a link between said network node and said at least one further network node.

In some example embodiments, said network node is further caused to perform prior to requesting said indication from said further network node: determining that said at least one further network node provides radio coverage in an area; requesting from a central network node a right to receive indications of quality of service for said at least one further network node.

In some example embodiments, said network node is further caused in response to receiving a plurality of quality of service indications for multiple cells in one area, to generate a combined value representative of said plurality of indications and to store said combined value as said indication for said area.

The network node generating the indications may generate a combined value for an area covered by multiple cells and reduce signalling by transmitting the single value to the receiving network node. Alternatively, the receiving network node may generate a combined value from multiple values and store and use that combined value. The combined value may be an indication of QoS as a number in a particular range of values.

In some example embodiments, said central network node comprises a network repository function.

In some example embodiments, said network node is further caused to perform generating a request for receiving updates of said at least one indication from said at least one further network node.

In some example embodiments, in response to said at least one indication indicating a quality of service provided by said at least one further network node being below a predefined value, generating a message for transmission to a user equipment, indicating said user equipment should not report radio link quality for cells within said area of radio coverage provided by said at least one further network node.

In some example embodiments, said message comprises an indication of time during which said user equipment should not report said radio link quality.

In some example embodiments, in response to expiry of said time and where said indication indicates said quality of service is still below said predefined value said network node is caused to remove a link between said network node and said further network node.

In some example embodiments, said quality of service comprises at least one of the following: cell average bit rate; cell maximum bit rate; cell guaranteed minimum bit rate; cell average packet delay; cell average packet loss rate, and cell worst case maximum packet loss rate.

In some example embodiments, said at least one area of radio coverage comprises at least one cell, at least one cell identifier identifying said at least one cell being transmitted with said indication.

In some example embodiments, said area of radio coverage comprises a plurality of cells and said indication comprising an indication of said average quality of service for said plurality of cells.

In some example embodiments, said step of evaluating comprises evaluating an average quality of service for said plurality of cells.

In some example embodiments, said at least one cell comprises at least one cell close to a boundary of said radio coverage provided by said network node.

In some example embodiments, said boundary is a boundary with radio coverage provided by said further network node.

According to various, but not necessarily all, example embodiments of the disclosure there is provided a network node for supporting providing radio coverage within a plurality of cells within a radio communication network, said network node comprising: means for receiving at least one indication of a quality of service that may be provided to a user equipment within at least one area of radio coverage provided by at least one further network node; means for storing said at least one indication; means for selecting a target cell in a handover process, said mean for selecting using said stored at least one indication as a factor in said selecting such that cells providing a higher quality of service are prioritised over cells providing a lower quality of service.

The means may perform the optional features set out in relation to the apparatus mentioned above.

According to various, but not necessarily all, example embodiments of the disclosure there is provided a network node for supporting providing radio coverage within a plurality of cells within a radio communication network, said network node comprising: circuitry configured to receive at least one indication of a quality of service that may be provided to a user equipment within at least one area of radio coverage provided by at least one further network node; circuitry configured to store said at least one indication; circuitry configured to select a target cell in a handover process, said circuitry configured to select being configured to use said stored at least one indication as a factor in said selecting such that cells providing a higher quality of service are prioritised over cells providing a lower quality of service.

The circuitry may be configured perform the optional features set out in relation to the apparatus mentioned above.

According to various, but not necessarily all, example embodiments of the disclosure there is provided a central network node within a radio communication network, said central network node comprising: at least one processor; and at least one memory storing instructions that when executed by the at least one processor cause the central network node at least to perform: receiving from at least some of a plurality of network nodes a list of served cells and an indication of an ability to perform generating a quality of service indication for an area covered by one or more of said served cells; storing said received list of served cells and indications; and in response to receipt of a request from a network node to access quality of service information for one of said plurality of network nodes providing said network node with access to said one of said plurality of network nodes.

The ability of network nodes to communicate information regarding the QoS they may offer in certain areas of radio coverage may be centrally managed at a central network node. This central network node may receive information regarding the ability of a network node to generate indications of QoS and it may use this when receiving a request to access such information to grant access rights, to a requesting network node.

In some example embodiments, said network node may be provided with access to a network node by providing it with an identifier identifying the network node. In some example embodiments this may be an address of the one of the plurality of network nodes.

In some example embodiments, said network node may be provided with access to a network node by providing it with an access token allowing it to communicate securely with said one of the plurality of network nodes.

In some example embodiments, said central network node comprises a network repository function.

According to various, but not necessarily all, example embodiments of the disclosure there is provided a central network node within a radio communication network, said central network node comprising: means for receiving from at least some of a plurality of network nodes a list of served cells and an indication of an ability to perform generating a quality of service indication for an area covered by one or more of said served cells; means for storing said received list of served cells and indications; and means for providing said network node with access to said one of said plurality of network nodes in response to receipt of a request from a network node to access quality of service information for one of said plurality of network nodes.

The central network node may comprise further means for performing the optional features set out in relation to the apparatus mentioned above.

According to various, but not necessarily all, example embodiments of the disclosure there is provided a central network node within a radio communication network, said central network node comprising: circuitry configured to receive from at least some of a plurality of network nodes a list of served cells and an indication of an ability to perform generating a quality of service indication for an area covered by one or more of said served cells; circuitry configured to store said received list of served cells and indications; and circuitry configured to provide said network node with access to said one of said plurality of network nodes in response to receipt of a request from a network node to access quality of service information for one of said plurality of network nodes.

The central network node may comprise further circuitry configured to perform the optional features set out in relation to the apparatus mentioned above.

According to various, but not necessarily all, example embodiments of the disclosure there is provided a user equipment comprising: at least one processor; and at least one memory storing instructions that when executed by the at least one processor cause the user equipment at least to perform: receiving from a serving network node an instruction to stop reporting radio link quality for at least one cell controlled by a further network node, said at least one cell being a cell whose quality of service has been indicated to be below a predetermined value; and in response not evaluating or reporting radio link quality for said at least one cell.

The ability for network nodes to know the QoS of areas of radio coverage provided by other network nodes, allows them to be aware of potential target cells that may not be able to provide the required QoS to a UE. UEs may receive a signal indicating that it should no longer report radio link quality for such cells. As these cells are not suitable as target cells, then power consumption and signalling can be reduced by instructing the UE to no longer report radio link quality for such cells. In response to this the UE may no longer perform the measurements and transmit the results.

In some example embodiments, said instruction comprises an indication of a time period during which said reporting of said radio link quality should not be performed by said user equipment.

In some example embodiments, the user equipment is further caused to perform: receiving a further instruction from said serving network node indicating said reporting of said radio link quality should be re-activated and in response evaluating and reporting radio link quality for said at least one cell controlled by said further network node.

In some example embodiments, said user equipment is further caused to perform: receiving a further instruction from said serving network node indicating said user equipment should stop reporting radio link quality for all cells provided by said further network node; and in response not evaluating or reporting radio link quality for all of said cells provide by said further network node.

According to various, but not necessarily all, example embodiments of the disclosure there is provided a user equipment comprising: means for receiving from a serving network node an instruction to stop reporting radio link quality for at least one cell controlled by a further network node, said at least one cell being a cell whose quality of service has been indicated to be below a predetermined value; and means for evaluating and reporting radio link quality for said at least one cell, said means for evaluating and reporting said radio link quality being configured in response to receipt of said instruction to stop reporting said radio link quality.

The user equipment may comprise further means for performing the optional features set out in relation to the apparatus mentioned above.

According to various, but not necessarily all, example embodiments of the disclosure there is provided a user equipment comprising: circuitry configured to receive from a serving network node an instruction to stop reporting radio link quality for at least one cell controlled by a further network node, said at least one cell being a cell whose quality of service has been indicated to be below a predetermined value; and circuitry configured to evaluate and report radio link quality for said at least one cell, said circuitry configured to evaluate and report said radio link quality being configured in response to receipt of said instruction to stop reporting said radio link quality.

The user equipment may comprise further circuitry configured to perform the optional features set out in relation to the apparatus mentioned above.

According to various, but not necessarily all, example embodiments of the disclosure there is provided a method performed at a network node, said method comprising: evaluating a quality of service that may be provided to a user equipment within at least one area of radio coverage provided by said network node; generating a corresponding at least one indication of said quality of service; and transmitting said at least one indication to a further network node within said radio communication network.

In some example embodiments, said method comprises performing: said evaluating, generating and transmitting in response to a request from said further network node.

In some example embodiments, said method comprises: transmitting said at least one indication to said further network node during a procedure for setting up a link between said network node and said further network node.

In some example embodiments, said method comprises: re-evaluating said quality of service and generating and transmitting an updated at least one indication after a predetermined time period.

In some example embodiments, said method comprises: determining when said evaluated quality of service falls below or rises above a predetermined threshold value and in response generating and transmitting an updated at least one indication.

In some example embodiments, said method comprises performing said determining in response to receipt of a request from said further network node for updates to said quality of service indications.

In some example embodiments, said method comprises performing: receiving at least one indication of a quality of service that may be provided to a user equipment within at least one area of radio coverage provided by at least one further network node; storing said at least one indication; using said stored at least one indication as a factor in selecting a target cell in a handover procedure, cells providing a higher quality of service being prioritised over cells providing a lower quality of service.

According to various, but not necessarily all, example embodiments of the disclosure there is provided a method performed at a network node, said method comprising: receiving at least one indication of a quality of service that may be provided to a user equipment within at least one area of radio coverage provided by at least one further network node; storing said at least one indication; using said stored at least one indication as a factor in selecting a target cell in a handover procedure, cells providing a higher quality of service being prioritised over cells providing a lower quality of service.

In some example embodiments, said method comprises performing: transmitting said request for said at least one indication during a procedure for setting up a link between said network node and said at least one further network node.

In some example embodiments, said method comprises performing: prior to requesting said indication from said further network node: determining that said at least one further network node provides radio coverage in an area; requesting from a central network node a right to receive indications of quality of service for said at least one further network node.

In some example embodiments, said method comprises in response to receiving a plurality of quality of service indications for multiple cells in one area, generating a combined value representative of said plurality of indications and storing said combined value as said indication for said area.

In some example embodiments, said method comprises generating a request for receiving updates of said at least one indication from said at least one further network node.

In some example embodiments, in response to said at least one indication indicating a quality of service provided by said at least one further network node being below a predefined value, generating a message for transmission to a user equipment, said message indicating said user equipment should not report radio link quality for cells within said area of radio coverage provided by said at least one further network node.

In some example embodiments, said message comprises an indication of time during which said user equipment should not report said radio link quality.

In some example embodiments, in response to expiry of said time and where said indication indicates said quality of service is still below said predefined value said method comprises removing a link between said network node and said further network node.

In some example embodiments, said step of evaluating comprises evaluating an average quality of service for said plurality of cells.

According to various, but not necessarily all, example embodiments of the disclosure there is provided a method performed at a central network node within a radio communication network, said method comprising: receiving from at least some of a plurality of network nodes a list of served cells and an indication of an ability to perform generating a quality of service indication for an area covered by one or more of said served cells; storing said received list of served cells and indications; and in response to receipt of a request from a network node to access quality of service information for one of said plurality of network nodes providing said network node with access to said one of said plurality of network nodes.

According to various, but not necessarily all, example embodiments of the disclosure there is provided a method performed at a user equipment, said method comprising: receiving from a serving network node an instruction to stop reporting radio link quality for at least one cell controlled by a further network node, said at least one cell being a cell whose quality of service has been indicated to be below a predetermined value; and in response not evaluating or reporting radio link quality for said at least one cell.

In some example embodiments, the method further comprises: receiving a further instruction from said serving network node indicating said reporting of said radio link quality should be re-activated and in response evaluating and reporting radio link quality for said at least one cell controlled by said further network node.

In some example embodiments, said method comprises: receiving a further instruction from said serving network node indicating said user equipment should stop reporting radio link quality for all cells provided by said further network node; and in response not evaluating or reporting radio link quality for all of said cells provide by said further network node.

According to various, but not necessarily all, example embodiments of the disclosure there is provided a non-transitory computer readable medium comprising program instructions stored thereon for controlling a network node to perform at least the following:

evaluating a quality of service that may be provided to a user equipment within at least one area of radio coverage provided by said network node;

generating a corresponding at least one indication of said quality of service; and causing transmission of said at least one indication to a further network node within said radio communication network.

According to various, but not necessarily all, example embodiments of the disclosure there is provided a computer program comprising instructions which when executed by a processor on a network node cause said network node to perform at least the following:

evaluating a quality of service that may be provided to a user equipment within at least one area of radio coverage provided by said network node;

generating a corresponding at least one indication of said quality of service; and causing transmission of said at least one indication to a further network node within said radio communication network.

According to various, but not necessarily all, example embodiments of the disclosure there is provided a non-transitory computer readable medium comprising program instructions stored thereon for controlling a network node to perform at least the following:

receiving at least one indication of a quality of service that may be provided to a user equipment within at least one area of radio coverage provided by at least one further network node;

storing said at least one indication;

using said stored at least one indication as a factor in selecting a target cell in a handover procedure, cells providing a higher quality of service being prioritised over cells providing a lower quality of service.

According to various, but not necessarily all, example embodiments of the disclosure there is provided a computer program comprising instructions which when executed by a processor on a network node cause said network node to perform at least the following: receiving at least one indication of a quality of service that may be provided to a user equipment within at least one area of radio coverage provided by at least one further network node;

storing said at least one indication;

using said stored at least one indication as a factor in selecting a target cell in a handover procedure, cells providing a higher quality of service being prioritised over cells providing a lower quality of service.

According to various, but not necessarily all, example embodiments of the disclosure there is provided a non-transitory computer readable medium comprising program instructions stored thereon for controlling a central network node to perform at least the following:

receiving from at least some of a plurality of network nodes a list of served cells and an indication of an ability to perform generating a quality of service indication for an area covered by one or more of said served cells;

storing said received list of served cells and indications; and in response to receipt of a request from a network node to access quality of service information for one of said plurality of network nodes providing said network node with access to said one of said plurality of network nodes.

According to various, but not necessarily all, example embodiments of the disclosure there is provided a computer program comprising instructions which when executed by a processor on a central network node cause said central network node to perform at least the following:

receiving from at least some of a plurality of network nodes a list of served cells and an indication of an ability to perform generating a quality of service indication for an area covered by one or more of said served cells;

storing said received list of served cells and indications; and

in response to receipt of a request from a network node to access quality of service information for one of said plurality of network nodes providing said network node with access to said one of said plurality of network nodes.

According to various, but not necessarily all, example embodiments of the disclosure there is provided a non-transitory computer readable medium comprising program instructions stored thereon for controlling a user equipment to perform at least the following:

receiving from a serving network node an instruction to stop reporting radio link quality for at least one cell controlled by a further network node, said at least one cell being a cell whose quality of service has been indicated to be below a predetermined value; and

in response not evaluating or reporting radio link quality for said at least one cell.

According to various, but not necessarily all, example embodiments of the disclosure there is provided a computer program comprising instructions which when executed by a processor on a user equipment cause said user equipment to perform at least the following:

receiving from a serving network node an instruction to stop reporting radio link quality for at least one cell controlled by a further network node, said at least one cell being a cell whose quality of service has been indicated to be below a predetermined value; and

in response not evaluating or reporting radio link quality for said at least one cell.

The instructions may be for performing the optional features set out in relation to the methods mentioned above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

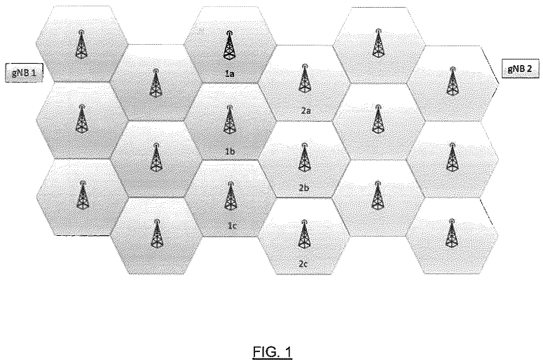

FIG. 1 schematically illustrates an example of two network nodes supporting providing radio coverage in cells;

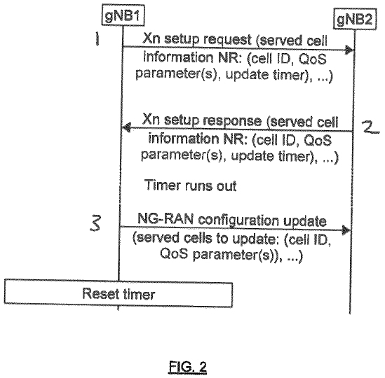

FIG. 2 schematically illustrates signalling between two network nodes exchanging cell QoS parameters over an Xn interface according to an embodiment;

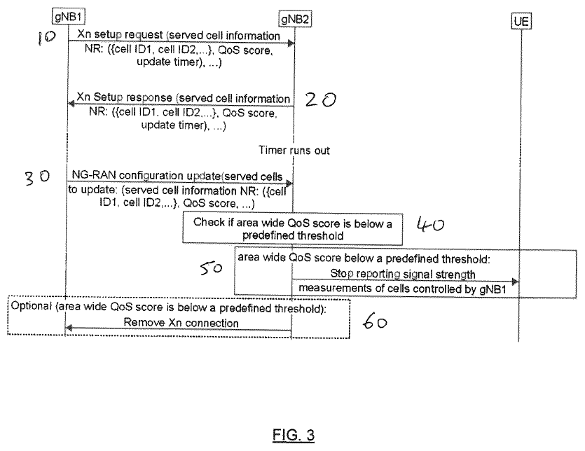

FIG. 3 schematically illustrates signalling between two network nodes exchanging area wide QoS parameters over an Xn interface according to an embodiment;

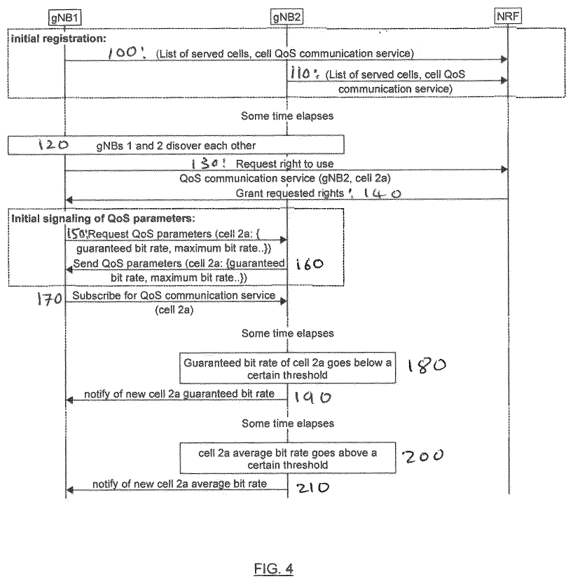

FIG. 4 schematically illustrates signalling between two network nodes exchanging cell QoS parameters in a service-based architecture network according to an embodiment; and

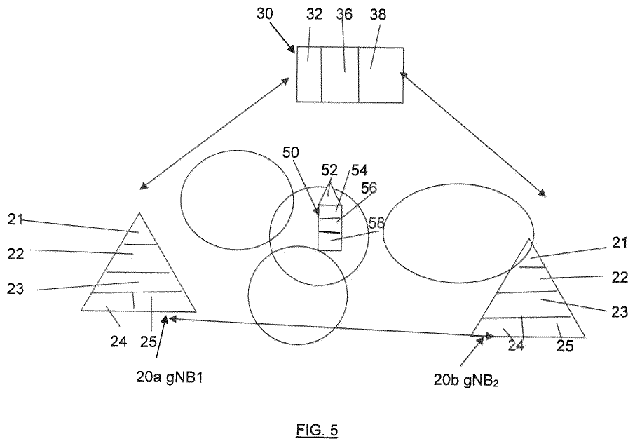

FIG. 5 schematically illustrates, a wireless network comprising two network nodes and a central network node according to an embodiment.

### DETAILED DESCRIPTION

Before discussing the example embodiments in any more detail, first an overview will be provided.

Different user equipment may have different service requirements and this may affect the choice of cell that would provide the most appropriate service for that user equipment. 5G systems have defined different 5G Quality of service (QOS) identifiers (5QI) for dealing with these different user equipment (UE) service requirements. Each 5QI corresponds to different QoS parameters such as packet error rate, packet delay budget, guaranteed bit rate—where the QoS flow profile is a guaranteed bit rate (GBR) profile (TS 23.501, Sec. 5.7.). Embodiments seek to provide enhanced methods for achieving neighbouring gNB/cell prioritization in the context of handovers by adaptively exchanging relevant QoS information among network nodes such as gNBs.

Current standards specify QoS parameter measurements to be performed or aggregated on a cell level in TSs 28.552 and TS 38.314. For instance, average packet delays and average UE throughput/bit rate (TS 28.552 Secs. 5.1.1.1. and 5.1.1.3.) can be measured by a gNB for each cell it controls. There are also QoS parameters that are desired by the UE and are part of the UE context and are exchanged among gNBs in an inter-gNB handover as part of the “PDU session resources to be setup list” information element in the case of a handover (TS 38.423 Sec. 9.1.1.1.). They relate to the quality of the link for the PDU (protocol data unit) that the UE may desire and are exchanged during a handover.

There is currently no exchange between gNBs of measured cell QoS parameters/situation in new radio NR. As a result, there are no mechanisms that enable a given gNB controlling a source cell to perform prioritization of neighbouring cells controlled by other gNBs based at least partially on QoS for potential handovers.

As an example and looking at FIG. 1, suppose a UE is present in cell 1a controlled by gNB 1, a handover to cell 2a (controlled by gNB 2) may fail in case cell 2a cannot satisfy the QoS parameters required by the user equipment. Alternatively, the UE could be handed over to cell 2a but the latter can barely satisfy the desired QoS requirements. In this case, there is the possibility that a UE is handed over to yet another cell (cell 3, controlled by gNB 3 and not shown) after a short time period if cell 2a becomes congested and can no longer satisfy the QoS requirements of the UE. This results in unnecessary performed handovers, more signalling traffic, and possible interruption of UE service time.

Embodiments propose to exchange QoS parameters among gNBs when establishing the relevant point-to-point backhaul links, i.e. this information could be part of the messages “Xn setup request” and “Xn setup response” (see 3GPP TS 38.423 Sec. 8.4.1.) between two gNBs in future systems. Cell QoS parameters defined in 3GPP TS 28.552 and 38.314 such as cell average or maximum bit rate, cell guaranteed (minimum) bit rate, cell average packet delay/loss rate, etc. can be exchanged among the gNBs. Alternatively, the information corresponding to multiple cells can be summarized by an area wide QoS score as detailed below.

As the QoS situation in a cell will vary over time due to various reasons (e.g. user traffic, desired slices, etc.) we propose two variants for keeping QoS parameters among gNBs up to date: Firstly the use of timers that specify how often the parameters should be exchanged, and secondly the use of subscribe-notify procedures via which a given QoS parameter is exchanged if it goes beyond/below a predefined threshold. The latter is best implemented within a service-based radio access network (RAN) architecture.

Some example embodiments seek to address the problems set out below.
1. In current 5G implementation, for non-GBR (non-guaranteed bit rate) QoS flows, there is no possibility to release data radio bearers (DRBs) even if the experienced bit rate by the UE is quite low. As a result, the UE may be stuck in a cell with very bad (low) maximum or average bit rate without the possibility for handover to other cells. Embodiments help ensure such scenarios don't occur by already including the QoS information during the backhaul link establishment. This ensures the UE is handed over to cells with acceptable QoS support for non-GBR QoS flows.
2. For GBR (guaranteed bit rate) flows, if two neighbouring cells with similar link quality offer GBRs of 10 Mbit/s and 15 Mbit/s respectively, and the user to be handed over requires a GBR of 9 Mbit/s, then the second neighbouring cell could be chosen for a handover as a result of prioritising cells using a factor based on their QoS properties. This decision preempts any future incoming traffic to the first neighbouring cell that may push its GBR below 9 Mbit/s, thus triggering an additional handover for the affected UE.

In effect by providing information regarding the QoS of a target cell to a network node, the network node is able to prioritise cells in a handover decision based on this QoS. Thus, where for example the UE service requirement indicates a need for a certain QoS threshold level, certain target cells that cannot provide such a QOS can be removed from the list of target cells considered in the handover decision. Where a set of cells each provide the required QoS, but certain cells provide a better QoS, then the selection may use the QOS as a factor in the decision, so that the better QoS cells may be preferentially selected, although the signals strengths will also be factors in the decision.

Embodiments described below relate to 1. current 5G RAN architecture (with gNBs connected via backhaul (Xn) interface) and 2. A new candidate service-based architecture for 6G RAN.

Part 1. 5G RAN architecture:

Initial exchange of QoS parameters: Current specifications (TS 38.423) have the information element (IE) “served cell information NR” of the messages “Xn setup request” and “Xn setup response”. This IE is specific for each served cell and contains several fields that could be relevant for neighbouring cells. We propose to include cell QoS information in the cell specific IE “served cell information IE”. QoS parameters that can be exchanged may include:
1. cell average bit rate (throughput),
2. cell maximum bit rate,
3. cell guaranteed (minimum) bit rate,
4. cell average packet delay,
5. cell average packet loss rate, and
6. cell worst case (maximum) packet loss rate.

In order to reduce signalling and avoid or at least reduce QoS information exchange of cells which are not relevant, only cells at the boundaries of areas controlled by the respective gNBs may be considered. For this, the gNBs can rely on help from O&M or they may use historical information (e.g. information about neighbouring cells in which handover has previously occurred and which has been stored to be used for this purpose). As shown in FIG. 1 only cells 2a, 2b and 2c (controlled by gNB2) are of interest for gNB1. Similarly, only cells 1a, 1b, and 1c (controlled by gNB 1) are of interest for gNB2.

This information helps a given gNB controlling a source cell to perform prioritization of neighbouring cells controlled by different gNBs for potential handovers.

Updating the QoS parameters: We propose to include the updated QoS information in the IE “served cells to update NR” of the message “NG-RAN node configuration update” in TS 38.423. This information can be updated based on predefined timers.

FIG. 2 illustrates the proposed signalling additions to current 5G RAN systems. As can be seen gNB₁ sends an initial set up request-message 1 which contains the served cell information. This IE information element is specific for each served cell and contains several fields that may be relevant for neighbouring cells. In some embodiments, QoS information is included within this IE indicating the QoS information that the network node gNB₁ can provide a UE with for the identified cells. These may be cells close to the boundary of the area of radio coverage provided by network node gNB₂. In this embodiment there is also an update timer value indicated and this indicates how often an update to the cell information is required. In other embodiments, the QoS information included within the IE may indicate the type of QoS information that is requested and in some cases the cell IDs identifying the cells of gNB₂ for which this QOS is requested. These may be cells close to the boundary of the area of radio coverage provide by network node gNB₁. Again, there may be an update timer value indicated and this indicates how often an update to the cell information is required.

The network node gNB₂ responds at message 2 with a Xn setup response which includes the served cell information for cells served by the node gNB₂ along with the cell IDs and QoS parameters for at least some of these cells along with an update timer indicating how often updates will be sent.

The signalling diagram also shows a further message, message 3 which is sent by gNB₁ after the update timer has expired for gNB₁ and this provides a configuration update relating to the served cells for gNB₁ and which comprises the cell ID's and the updated QoS parameters.

For each nodes gNB₁ and gNB₂ that receive QoS information, this information is stored in a data store and may then be used in handover decisions.

After message 3 is sent the timer is reset such that after the predetermined time has elapsed again further information will be sent by gNB₁.

In some embodiments, where the initial exchange, as well as further updating of multiple QoS parameters is signalling intensive, even when the cells whose information can be exchanged is restricted to say neighbouring cells, then in some embodiments a given gNB may map the relevant cells' QoS parameters to a QoS score, e.g., between 0 and 100. This can be done based on a machine learning or an optimization method. This unique QoS score is an area wide average score: It may be representative of relevant cells that are controlled by a target gNB and that are neighbours of cells controlled by the source gNB.

Building on FIG. 1 above, two QoS scores can be created, corresponding to the areas represented by cells (1a, 1b, 1c) and (2a, 2b, 2c), respectively. This score can be then exchanged among gNBs in a similar way to that discussed above and can furthermore be slice dependent. This also helps prioritization: if most cells have bad QoS parameters, the corresponding QoS score will be low. Handovers to any cells within this area will be down prioritized or avoided.

In a further embodiment the source gNB may receive different QoS parameters corresponding to multiple neighbouring cells from the target gNB but processes it itself to a combined QoS score, that it stores and uses as a factor in handover decisions.

In some embodiments, based on the QoS score, the source gNB may ask UEs to stop reporting radio link quality to those aforementioned neighbouring cells controlled by another gNB if the given QoS score of that other gNB is below a certain threshold. This could be for some configured time interval (Toff, 1), after which the reporting can be activated again. If the QoS score is still below the given threshold for a time interval larger than (Toff,2), then the UEs can be instructed to stop reporting again. The Xn connection may even be removed in case the transport plane needs to be offloaded. In that case, we have an area wide barring due to bad QoS conditions.

FIG. 3 illustrates the proposed QoS score embodiment signalling among gNBs. In contrast to FIG. 2, the QoS score now corresponds to multiple cells (denoted with cell ID1, cell ID2, . . . ).

In a first message 10 the Xn setup request is sent for gNB₁ to gNB₂ as in FIG. 2 but in this case the combined QoS score for those cells is the QOS that is provided or requested. A timer value is again sent. There is a response from gNB₂ at message 20 and again in this particular example, an average combined QoS score for the combined area of multiple cells is sent along with the cell IDs indicating the combined area and the timer value.

When the timer runs out at 30 an updated configuration message is sent with the newly evaluated QoS scores for the combined area of the cells. At step 40, if gNB₂ determines from the received updated QoS values that the area wide QoS score is below a predefined threshold then it may generate and transmit a message to a UE being served by gNB₂ at step 50 indicating that the UE should stop reporting signal strength measurements for cells controlled by gNB₁. At step 60 gNB₂ may remove the backhaul link connection with gNB₁.

In some embodiments where the configuration update indicates the QoS score is below a predefined threshold for an individual cell of gNB₁, then a user equipment may receive a signal from gNB₂ indicating it should no longer report signal strengths for that particular cell. In this case the backhaul link is not removed and other potential target cells of gNB₁ may still be reported by the UE.

### Part 2. Service-Based Architecture (SBA):

We present in the following an embodiment assuming an SBA for the RAN. Here, there are no point-to-point Xn links between gNBs. Rather, gNBs have URI/IP addresses and are connected via a service bus interface. This architecture is beneficial for “subscribe-notify” interactions among gNBs. We define a new gNB service denoted QoS communication service, which allows a given gNB to communicate cell specific QoS parameter changes to other authorized entities (e.g. other gNBs). The subscription rights may be managed by a RAN network repository function (NRF) (alternatively O&M), and the new service can be registered with the NRF in an initial step (e.g. at system start up).

As an example of subscribe-notify procedures, if a cell average bit rate or cell guaranteed bit rate goes above or below a certain threshold the gNB controlling the aforementioned cell can promptly notify the gNB controlling a neighbour cell of this update (under the condition it has previously subscribed to the QoS communication service of the former gNB). The latter can then update its gNB/neighbour cell prioritization.

FIG. 4, using cells from FIG. 1, shows the envisioned QoS parameter signalling in an SBA, including the initial service registration with the NRF.

FIG. 4 shows signalling for a service-based architecture network where there is a central network node which supports a network repository function. In this embodiment there is an initial registration stage where each of the network nodes gNB₁ and gNB₂ send messages to the network repository function at 100 and 110 respectively. The messages list their served cells and indicate their ability to determine QoS parameters for these cells and to report the determined QoS. They may also indicate the ability of the network node to process received QoS indications for cells of other network nodes and use them in their handover decisions.

Messages 100 and 110 are sent during initial registration and after some time when the two nodes gNB₁ and gNB₂ discover each other, perhaps in response to a user equipment indicating that a cell from one of these nodes may be a target cell, then gNB₁ may send a message to the network repository function requesting the right to use the QoS communication service of gNB₂. The NRF may grant the requested rights at message 140. This may be in the form of a message indicating an identifier for the network node gNB₂ so that gNB₁ can communicate with it and/or it may comprise one or more tokens that allow a secure link to be set up between the two network nodes.

Following this at steps 150 and 160 there is then the initial signalling of QoS parameters between the two nodes, so that at message 150 gNB₁ requests the QoS parameters for cell 2a from gNB₂ and indicates in the message the desired QoS parameters. In this case it is guaranteed bit rate and maximum bit rate. At step 160 gNB₂ replies and sends the QoS parameters requested for that cell. At message 170 the gNB₁ may subscribe for the QoS communication service, perhaps for a particular cell, cell 2A of gNB₂ such that it will receive updates in the future for any changes to that cell. After some time at step 180 if the guaranteed bit rate of cell 2A goes below a certain threshold then in response to this gNB₂ may send a message 190 notifying gNB₁ of the updated guaranteed bit rate for cell 2A. After some time elapses the average bit rate for the cell may go above the predetermined threshold and at that point at step 200 gNB₂ may send a message at 210 notifying gNB₁ of the updated average bit rate. In this way, the network node is kept apprised of changes to the quality of service provided by the other network node for cells of interest.

Alternatively, the service may only include the QoS area wide score as discussed above. However, this is less relevant in an SBA as gNBs are always connected to each other and can therefore do a sub area (on a cell level granularity) prioritization/barring based on the cell specific QoS parameters.

FIG. 5 schematically shows a wireless communication network comprising two network nodes and a central network node according to an embodiment.

FIG. 5 schematically shows a wireless communication network according to an embodiment. In FIG. 5 there are two network nodes gNB₁ 20a and gNB₂ 20b. There is a backhaul link between the two network nodes that allows them to transmit signals between each other. In some embodiments rather than having a backhaul link the link between them may be provided by a service bus interface.

Network node 20a comprises transmitting and receiving circuitry 21 for transmitting signals to a user equipment 50 and a central network node 30 and for receiving signals from these entities. It also comprises circuitry 22 for evaluating a QoS that it provides in one or more of its cells. There is indication generating circuitry 23 that is configured to generate an indication of the evaluated QoS. This generating circuitry 23 may generate an indication of the actual value or it may generate an indication of the value relative to a threshold or an indication of an average of several values, or of the values for several cells. The advantage of transmitting an indication of a QoS value rather than the value itself is that reduced signalling may be achieved.

There is a data store 24 for storing indications of QoS that are received from other network nodes such as gNB₂ 20b. These may be received via the backhaul link during a set up procedure for example or they may be received during some update procedure, or because the network node has subscribed to updates of this information. Network node 20a also has handover determining circuitry 25 for selecting target cells for a handover for a user equipment 50 that is currently served by network node 20a and that is moving towards network node 20b. This handover determining circuitry 25 may receive signal strength measurements from the UE 50 relating to potential target cells. It may also consider the QoS indications for those target cells that have been received from network node gNB₂ 20b that is stored in data store 24. The service requirements of user equipment 50 may also be taken into account as these may affect the QoS that is required by the user equipment.

Network node gNB₂ 20b comprises corresponding circuitry to that of network node 20a.

In this embodiment there is a central network node 30 that may comprise the network repository function and which comprises a data store 32 for storing the list of served cells of each network node and an indication as to whether or not they have the ability to provide an indication of QoS for these cells and/or to use such a QoS indication in their handover decisions. Central network node 30 may also comprise transmitting and receiving circuitry 38 for transmitting and receiving signals to and from the network nodes and subscriber management circuitry 36 configured to process requests received from a network node requesting the right to receive QoS communications from another network node and to grant or refuse that right. The granting of the right may be done by generating an identifier identifying the another network node which is sent to the requesting network node allowing it to communicate with the another network node. In some cases where the communication is to be a secure communication token generation circuitry 36 within subscriber management circuitry may generate secure tokens that are communicated to the network nodes and allow the network nodes to communication securely with each other.

User equipment 50 which may be a smart phone comprises transmitting and receiving circuitry 52 for transmitting and receiving signals with the different network nodes 20a, 20b. User equipment 50 also comprises measuring circuitry 54 for measuring radio quality links and report generating circuitry 56 for generating reports of the radio quality links. User equipment 50 also comprises control circuitry 58 configured to respond to receipt of an instruction from a network node indicating that the reporting of radio link quality for a particular cell or a particular network node should be halted, to control the measuring circuitry 54 and report generating circuitry 56 to halt the link quality estimation and reporting. Control circuitry 58 is also configured in response to receipt of a signal indicating that the radio link quality monitoring should start again to control the circuitry 54, 56 to start monitoring and reporting radio link quality again.

In this way, a wireless communication network is provided that allows the transfer of information between network nodes relating to the quality of service that they may provide in one or more cells. This information allows them to factor quality of service provisions into handover decision for such cells and helps reduce the risk of a user equipment transferring to a cell that cannot provide the desired level of quality of service.

The identified UE impacts are:
1. Reduction of signalling over the air interface (to the source cell/gNB) in case neighbouring cell QoS parameters fall below/above a certain threshold, as the UEs may be instructed to stop reporting radio link quality of neighbour cells
2. Reduction of service interruption time and unnecessary handovers

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1.-25. (canceled)

26. A network node for supporting providing radio coverage within a plurality of cells within a radio communication network, said network node comprising:
at least one processor; and
at least one memory storing instructions that when executed by the at least one processor cause the network node at least to perform:
evaluating a quality of service that may be provided to a user equipment within at least one area of radio coverage provided by said network node;
generating a corresponding at least one indication of said quality of service; and
transmitting said at least one indication to a further network node within said radio communication network.

27. The network node according to claim 26, wherein said network node is caused to perform: said evaluating, generating and transmitting in response to a request from said further network node.

28. The network node according to claim 26, wherein said network node is caused to perform: transmitting said at least one indication to said further network node during a procedure for setting up a link between said network node and said further network node.

29. The network node according to claim 26, wherein said network node is further caused to perform: re-evaluating said quality of service and generating and transmitting an updated at least one indication after a predetermined time period.

30. The network node according to claim 26, wherein said network node is further caused to perform: determining when said evaluated quality of service falls below or rises above a predetermined threshold value and in response generating and transmitting an updated at least one indication.

31. The network node according to claim 30, said network node being caused to perform said determining in response to receipt of a request from said further network node for updates to said quality of service indications.

32. The network node according to claim 26, said network node being further caused at least to perform:
receiving at least one indication of a quality of service that may be provided to a user equipment within at least one area of radio coverage provided by at least one further network node;
storing said at least one indication;
using said stored at least one indication as a factor in selecting a target cell in a handover procedure, cells providing a higher quality of service being prioritized over cells providing a lower quality of service.

33. A network node for supporting providing radio coverage within a plurality of cells within a radio communication network, said network node comprising:
at least one processor; and
at least one memory storing instructions that when executed by the at least one processor cause the network node at least to perform:
receiving at least one indication of a quality of service that may be provided to a user equipment within at least one area of radio coverage provided by at least one further network node;
storing said at least one indication;
using said stored at least one indication as a factor in selecting a target cell in a handover procedure, cells providing a higher quality of service being prioritized over cells providing a lower quality of service.

34. The network node according to claim 33, said network node being further caused to perform:
prior to receiving said at least one indication:
generating a request for said at least one indication;
transmitting said request to said at least one further network node.

35. The network node according to claim 34, wherein said network node is caused to perform: transmitting said request for said at least one indication during a procedure for setting up a link between said network node and said at least one further network node.

36. The network node according to claim 34, said network node being further caused to perform prior to requesting said indication from said further network node:
determining that said at least one further network node provides radio coverage in an area;
requesting from a central network node a right to receive indications of quality of service for said at least one further network node.

37. The network node according to claim 36, said network node being further caused to perform generating a request for receiving updates of said at least one indication from said at least one further network node.

38. The network node according to claim 33, wherein in response to said at least one indication indicating a quality of service provided by said at least one further network node being below a predefined value, generating a message for transmission to a user equipment, indicating said user equipment should not report radio link quality for cells within said area of radio coverage provided by said at least one further network node.

39. The network node according to claim 38, wherein said message comprises an indication of time during which said user equipment should not report said radio link quality.

40. The network node according to claim 33, wherein said quality of service comprises at least one of the following: cell average bit rate; cell maximum bit rate; cell guaranteed minimum bit rate; cell average packet delay; cell average packet loss rate, and cell worst case maximum packet loss.

41. The network node according to claim 33, wherein said area of radio coverage comprises a plurality of cells and said indication comprising an indication of said average quality of service for said plurality of cells.

42. A user equipment comprising:
at least one processor; and
at least one memory storing instructions that when executed by the at least one processor cause the user equipment at least to perform:
receiving from a serving network node an instruction to stop reporting radio link quality for at least one cell controlled by a further network node, said at least one cell being a cell whose quality of service has been indicated to be below a predetermined value; and
in response not evaluating or reporting radio link quality for said at least one cell.

43. The user equipment according to claim 42, the user equipment being further caused to perform:
receiving a further instruction from said serving network node indicating said reporting of said radio link quality should be re-activated and in response evaluating and reporting radio link quality for said at least one cell controlled by said further network node.

44. The user equipment according to claim 42, said user equipment being further caused to perform:
receiving a further instruction from said serving network node indicating said user equipment should stop reporting radio link quality for all cells provided by said further network node; and
in response not evaluating or reporting radio link quality for all of said cells provide by said further network node.
